(19) United States
(12) Patent Application Publication
(10) Pub. No.: US 2010/0135392 A1
(43) Pub. Date: Jun. 3, 2010

(54) IMAGE DISPLAY APPARATUS, IMAGE TRANSMITTING APPARATUS, IMAGE TRANSMITTING METHOD AND RECORDING MEDIUM

(76) Inventor: Duk-Sung KIM, Seoul (KR)

Correspondence Address: BIRCH STEWART KOLASCH & BIRCH, PO BOX 747, FALLS CHURCH, VA, 22040-0747, US

(21) Appl. No.: 12/628,172

(22) Filed: Nov. 30, 2009

(30) Foreign Application Priority Data
Dec. 1, 2008 (KR) 10-2008-0120272

(51) Int. Cl. H04B 1/66

(52) U.S. Cl. 375/240.13; 375/E07.02

(57) ABSTRACT

An image display apparatus including an image receiver configured to receive video data structured by a plurality of bit streams, an image processor configured to process the received video data into a reproducible format, and an image output unit configured to output video relating to the data processed into the reproducible format. Further, the plurality of bit streams include a first bit stream having a first bit rate and having a format defined by a first group of pictures (GOP), and a second bit stream having a second bit rate and having a format defined by a second group of pictures (GOP)s. In addition, the received video data includes a mixture of the first GOPs from the first bit stream and the second GOPs from the second bit stream in which each of the GOPs included in the received video data begins with an intra-frame (I-frame) and ends with the I-frame or a predicted-frame (P-frame), and includes a bidirectional-frame (B-frame) between the beginning and end frames such that the first and second GOPs are reproduced independently from each other.

### CROSS-REFERENCE TO A RELATED APPLICATION

Pursuant to 35 U.S.C. §119(a), this application claims the benefit of the earlier filing date and right of priority to Korean Application No. 10-2008-0120272, filed on Dec. 1, 2008, the contents of which is incorporated by reference in its entirety.

### BACKGROUND OF THE INVENTION

1. Field of the Invention

The present invention relates to an image apparatus and corresponding method and recording medium for producing video data depending on a transmission environment of a network.

2. Background of the Invention

A streaming service is a service in which video data (e.g., moving picture, moving image, etc.) is streamed or downloaded from a server to an image display apparatus. The streamed video data is generated and transmitted according to the moving picture expert group (MPEG) standardization established by MPEG, which is a moving picture research group under the International Organization for standardization (ISO/IEC).

Image display apparatuses that can receive and reproduce streaming contents include stationary terminals such as desktop computers, IP TVs and the like, and also include mobile terminals such as mobile communication terminals, navigation apparatuses, telematics terminals, portable multimedia players (PMPs), laptop computers and the like. In addition, the transmission environments of a network providing the streaming service may change due to various reasons such as an increase in the number of streaming users, physical obstacles of the network, server failure, etc. Thus, the streaming service can be interrupted or even halted, which inconveniences the user.

### SUMMARY OF THE INVENTION

Accordingly, one object of the present invention is to address the above-noted and other problems.

Another object of the present invention is to provide a quality of service (QoS) that is higher than a specific level for a streaming service.

To achieve these and other advantages and in accordance with the purpose of the present invention, as embodied and broadly described herein, the present invention provides in one aspect an image display apparatus including an image receiver configured to receive video data structured by a plurality of bit streams, an image processor configured to process the received video data into a reproducible format, and an image output unit configured to output video relating to the data processed into the reproducible format. Further, the plurality of bit streams include a first bit stream having a first bit rate and having a format defined by a first group of pictures (GOP), and a second bit stream having a second bit rate and having a format defined by a second group of pictures (GOP)s. In addition, the received video data includes a mixture of the first GOPs from the first bit stream and the second GOPs from the second bit stream in which each of the GOPs included in the received video data begins with an intra-frame (I-frame) and ends with the 1-frame or a predicted-frame (P-frame), and includes a bidirectional-frame (B-frame) between the beginning and end frames such that the first and second GOPs are reproduced independently from each other.

In another aspect, the present invention provides an image transmitting apparatus including a database configured to store a plurality of bit streams having different bit rates, a network detector configured to detect a change in a network transmission environment, a controller configured to select a bit stream from the plurality of bit streams transmittable under the detected network transmission environment, and a data transmitter configured to transmit the selected bit stream on a per GOP basis. Further, the plurality of bit streams include a first bit stream having a first bit rate and having a format defined by a first group of pictures (GOP), and a second bit stream having a second bit rate and having a format defined by a second group of pictures (GOP)s. In addition, the transmitted bit stream includes a mixture of the first GOPs from the first bit stream and the second GOPs from the second bit stream in which each of the GOPs included in the transmitted bit stream begins with an intra-frame (I-frame) and ends with the I-frame or a predicted-frame (P-frame), and includes a bidirectional-frame (B-frame) between the beginning and end frames such that the first and second GOPs are reproduced independently from each other.

In yet another aspect, the present invention provides a recording medium including record video information to be reproduced by an image display apparatus, the recording medium including recorded video data structured by a plurality of bit streams. Further, the plurality of bit streams include a first bit stream having a first bit rate and having a format defined by a first group of pictures (GOP), and a second bit stream having a second bit rate and having a format defined by a second group of pictures (GOP)s. In addition, the recorded video data includes a mixture of the first GOPs from the first bit stream and the second GOPs from the second bit stream in which each of the GOPs included in the received video data begins with an intra-frame (I-frame) and ends with the I-frame or a predicted-frame (P-frame), and includes a bidirectional-frame (B-frame) between the beginning and end frames such that the first and second GOPs are reproduced independently from each other.

In still another aspect, the present invention provides an image transmitting method including storing a plurality of bit streams having different bit rates and each including one or more groups of pictures (GOPs), detecting a network transmission environment, and selecting one bit stream from bit streams transmittable under the detected network transmission environment, and transmitting the selected bit stream on a per GOP basis. Further, the plurality of bit streams include a first bit stream having a first bit rate and having a format defined by a first group of pictures (GOP), and a second bit stream having a second bit rate and having a format defined by a second group of pictures (GOP)s. In addition, the transmitted bit stream includes a mixture of the first GOPs from the first bit stream and the second GOPs from the second bit stream in which each of the GOPs included in the transmitted bit stream begins with an intra-frame (I-frame) and ends with the I-frame or a predicted-frame (P-frame), and includes a bidirectional-frame (B-frame) between the beginning and end frames such that the first and second GOPs are reproduced independently from each other.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an overview of a streaming service system according to an embodiment of the present invention;

FIG. 2 is a block diagram of an image display apparatus according to an embodiment of the present invention;

FIG. 3 is a block diagram of an image transmitting apparatus according to an embodiment of the present invention;

FIG. 4 is an overview showing a data format stored in a recording medium according to an embodiment of the present invention;

FIG. 5 is an overview showing a video information format transmitted by an image reproducing method according to an embodiment of the present invention; and

FIG. 6 is a flowchart showing an image transmitting method according to an embodiment of the present invention.

### DETAILED DESCRIPTION OF THE INVENTION

Reference will now be made in detail to the preferred embodiments of the present invention, examples of which are illustrated in the accompanying drawings.

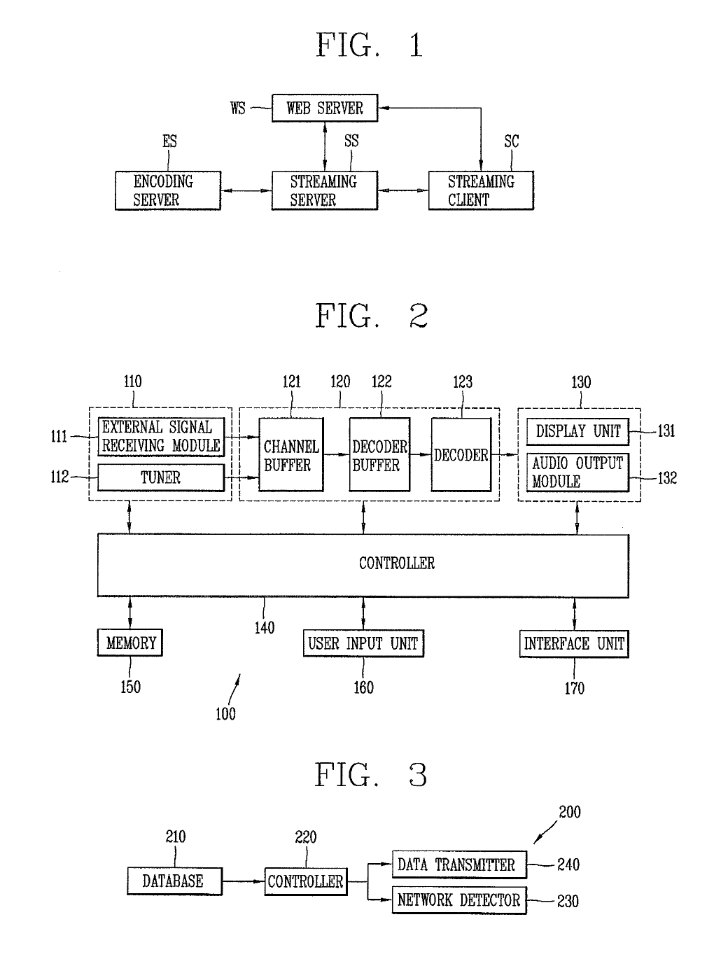

FIG. 1 is an overview of a streaming service system providing a streaming service according to an embodiment of the present invention. As shown in FIG. 1, the streaming service system includes a web server WS, a streaming server SS, a streaming client SC, and an encoding server ES, which receives real-time video information from a contents provider CP. In particular, the encoding server ES converts video information received in real time into video data in a video format used for a streaming service. The encoding server ES then transmits the video data to the streaming server SS.

Further, the streaming client SC includes an image display apparatus 100 for reproducing received video data (see FIG. 2), and the streaming server SS includes an image transmitting apparatus 200 (see FIG. 3). Also, when the streaming client SC requests streaming data, the streaming server SS transmits the data to the streaming client SC. The streaming server SS can also read a header of the stored video data to determine the format, bit rate and the like of the video data to be transmitted, and determine a proper data transmission speed based upon the determined format, bit rate and the like.

In addition, the streaming server SS can transmit statistical information (e.g., a time stamp, the number of cumulative packets, etc.) of the network to the streaming client SC, and also receive statistical information (e.g., the number of cumulative packets lost, packet jitter, etc.) from the streaming client SC. The streaming server SS also detects transmission environments of the network based upon the statistical information. Further, the network transmission environments may include transmission or non-transmission of video data between the streaming server SS and the streaming client SC, available bandwidth information upon transmission, etc.

The streaming server SS can also receive video data in real time from the encoding server ES or another server and transmit the received video data to the streaming client SC. In addition, the streaming client SC can access the streaming server SS via the web server WS or directly access the streaming server SS to request video data. The streaming client SC and the web server WS can also be connected to each other via an Internet network.

In addition, in FIG. 1, the web server WS is connected to the streaming server SS, and thus the streaming client SC can receive a list of video data provided by the streaming service via the web server WS. The streaming client SC can also transmit a request signal to the streaming server SS via the web server WS to request video data. The streaming client SC can also receive the streaming service using a web page provided via the web server WS.

Further, the web server WS can provide a list of video data which can be provided to the streaming client SC through the streaming service. The web server WS can command the streaming server SS to transmit video data to the streaming client SC in response to the video data request from the streaming client SC.

Hereinafter, the image display apparatus 100 in FIG. 2 according to an embodiment of the present invention will be described. The image display apparatus 200 refers to electronic equipment that can reproduce received moving pictures such as televisions, DVD players, optical disk players, mobile phones, smart phones, notebook computers, digital broadcast terminals, personal digital assistants (PDAs), portable multimedia players (PMPs), navigation apparatuses and the like.

As shown in FIG. 2, the image display apparatus 100 includes an image receiver 110, an image processor 120, an image output unit 130, a controller 140, a memory 150, a user input unit 160 and an interface unit 170. However, all of the illustrated components are not a requirement, and greater or fewer components may alternatively be implemented. In addition, the image receiver 110 can receive an external image signal and/or image associated information, and transmit the received image signal and/or image associated information to the image processor 120. In FIG. 2, the image receiver 110 includes an external signal receiving module 111 and a tuner 112.

The external signal receiving module 111 can receive external signals input via external devices such as digital versatile disks (DVDs), set top boxes, camcorders and/or networks such as wired/wireless Internet network and the like. Examples of wireless Internet networks include Wireless LAN (WLAN) (Wi-Fi), Wireless Broadband (Wibro), Worldwide Interoperability for Microwave Access (Wimax), High Speed Downlink Packet Access (HSDPA) and the like. Examples of wired Internet networks include Ethernet, the hybrid fiber coax (HFC) network, the asymmetric digital subscriber line (ADSL) network, the very high-data rate digital subscriber line (VDSL) network, the fiber-to-the-home (FTTH) network, the power line communication (PLC) network and the like.

In addition, the external device and the image display apparatus 100 can be connected to each other by wire or wirelessly through the external signal receiving module 111. The external device and the image display apparatus 100 can also be connected wirelessly using a short-range communication technology such as BLUETOOTH, Radio Frequency IDentification (RFID), Infrared Data Association (IrDA), Ultra-WideBand (UWB), ZigBee, etc.

Further, the tuner 112 can receive a broadcast signal and/or broadcast associated information from an external broadcast managing entity via a broadcast channel. The broadcast channel may include a satellite channel and a terrestrial channel, and the broadcast managing entity may indicate a server which generates and transmits a broadcast signal and/or broadcast associated information or a server which receives a pre-generated broadcast signal and/or broadcast associated information and sends them to the portable terminal. The broadcast signal may be implemented as a TV broadcast signal, a radio broadcast signal, and a data broadcast signal, among others. Also, the broadcast signal may further include a data broadcast signal combined with a TV or radio broadcast signal.

Examples of broadcast associated information include information associated with a broadcast channel, a broadcast program, a broadcast service provider, and the like. The broadcast associated information can also be provided via a mobile communication network and also be implemented in various formats. For instance, the broadcast associated information may include an Electronic Program Guide (EPG) of the Digital Multimedia Broadcasting (DMB) system, an Electronic Service Guide (ESG) of the Digital Video Broadcast-Handheld (DVB-H) system, and the like.

The tuner 112 can also be configured to receive digital broadcast signals transmitted from various types of broadcast systems. Such digital broadcast systems may include the Digital Multimedia Broadcasting-Terrestrial (DMB-T) system, the Digital Multimedia Broadcasting-Satellite (DMB-S) system, the Media Forward Link Only (MediaFLO) system, Digital Video Broadcast-Handheld (DVB-H), Integrated Services Digital Broadcast-Terrestrial (ISDB-T) system, etc. The tuner 112 can also be configured to be suitable for other broadcast systems as well as digital broadcast systems.

In addition, the image signal and/or image associated information received by the image receiver 110 can be stored in the memory 150. Also, the image processor 120 can receive an image signal from the image receiver 110 and process the received image signal so as to be output by the image output unit 130. In FIG. 1, the image processor 120 includes a channel buffer 121, a decoder buffer 122 and a decoder 123. In more detail, the channel buffer 121 can receive an image signal from the image receiver 110 and temporarily store the received image signal. The image signal can also be stored in a data stream format as a combination of video data for video reproduction and audio data for audio reproduction.

Further, the data stored in the channel buffer 121 can be deleted after being transmitted to the decoder buffer 122. Alternatively, the data stored in the channel buffer 121 can be stored for a preset time after being transmitted to the decoder buffer 122. In addition, the decoder buffer 122 can temporarily store audio data and video data divided from the data stream. The audio data and the video data temporarily stored in the decoder buffer 122 are then transmitted to the decoder 123.

In addition, the data stored in the decoder buffer 122 can be deleted after being transmitted to the decoder 123. In particular, the data stored in the decoder buffer 122 may be immediately deleted after being transmitted to the decoder 123 or deleted after a preset time elapses after the transmission. Further, the decoder 123 converts the video or audio data into a format to be useable by the controller 140 or the audio output unit 130.

The video and/or audio data can also be in a variety of formats such as a format of audio video interleaved (AVI), MPEG, DivX, XviD, windows media video codec (WMV) or the like and may be encoded/decoded. The image output unit 130 also reproduces image (video) and/or sound (audio) using the data converted by the decoder 123. In FIG. 2, the image output unit 130 includes a display unit 131 and an audio output module 132.

In particular, the display unit 131 can output information processed in the image display apparatus 100. For example, when the image display apparatus 100 is operating in a video output mode, the display unit 131 output videos (e.g., moving picture, motion picture, moving image, etc.). Also, when the image display apparatus 100 is in an Internet communication mode, the display unit 131 displays a user interface (UI) or a graphic user interface (GUI) which includes information associated with the Internet communication.

Further, the display unit 131 may be implemented using, for example, a Liquid Crystal Display (LCD), a Thin Film Transistor-Liquid Crystal Display (TFT-LCD), an Organic Light-Emitting Diode (OLED), a flexible display, a Field Emission Display (FED), a three-dimensional (3D) display, a plasma display panel (PDP), a multi display tube (MDT), a transparent display, etc. In addition, the audio output module 132 can output audio or sound data decoded by the decoder 123, and may be implemented, for example, using a dynamic speaker, an electrostatic speaker, a planar-magnetic speaker and the like.

Also, the controller 140 controls the overall operations of the image display apparatus 100. For example, the controller 140 processes data received via the image receiver 110 or data stored in the memory 150. The controller 140 can also include a digital signal processor (DSP). Further, the memory 150 stores a program for process and control of the controller 140 and/or temporarily stores input/output data. The memory 150 may be implemented using any type of suitable storage medium including a flash memory type, a hard disk type, a multimedia card micro type, a memory card type (e.g., SD or XD memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like. In addition, the image display apparatus 100 may operate a web storage on the Internet which performs a storage function of the memory 150.

Further, the user input unit 160 can receive a signal to control the operation of the image display apparatus 100. The signal may indicate a signal to control the operation (Rewind, Fast-Forward, Pause, Record, etc.) of a moving image being currently reproduced. Alternatively, the signal may indicate a signal to control the operation of the image display apparatus 100 such as power ON/OFF, reservation recording, Internet communication module Enable/Disable, short range wireless communication module Enable/Disable, broadcast channel change function, volume control function, mute function, etc. Audio data or video data can also be directly input to the user input unit 160 by a user through a camera or a microphone in addition to the signal to control the operation of the image display apparatus 100. Also, the signals can be input directly by a user or indirectly input using a wired/wireless remote controller.

In addition, the interface unit 170 is implemented to interface the image display apparatus 100 with external devices. The interface unit 170 can also allow a data reception from an external device, a power delivery to each component in the image display apparatus 100, or a data transmission from the image display apparatus 100 to an external device. In particular, the interface unit 170 may include, for example, wired/wireless headset ports, external charger ports, wired/wireless data ports, memory card ports, ports for coupling devices having an identification module, audio Input/Output (I/O) ports, video I/O ports, earphone ports, and the like.

Also, for a hardware implementation, the embodiments described herein may be implemented within one or more of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, micro processors, other electronic units designed to perform the functions described herein, or a selective combination thereof. In some instances, such embodiments are implemented by the controller 140.

For a software implementation, the embodiments such as procedures and functions may be implemented together with separate software modules each of which performs at least one of functions and operations. The software codes can be implemented with a software application written in any suitable programming language. Also, the software codes may be stored in the memory 150 and executed by the controller 140.

In addition, according to an embodiment of the present invention, moving pictures (e.g., motion pictures, moving images, videos, etc.), video data is formed by a collection (series, sequence) of a group of pictures (GOPs) as a basic unit for encoding. The GOP denotes a series of frames starting with an I-frame, which will be explained later, to the next I-frame. The GOP can also be structured in a group of three types of frames including an intra-frame (I-frame), a bidirectional-frame (B-frame) and a predicted-frame (P-frame).

In addition, the frame denotes a data unit containing information used for reproducing individual still images configuring a moving picture. The I-frame is also called as a key frame, and denotes data containing compressed information related to a random screen of a moving picture. Also, the I-frame has video data with the highest quality and is generally the largest in size. The P-frame denotes data configuring a screen based upon information of a key frame located prior to the corresponding frame. The P-frame is also smaller in size and lower in quality than the I-frame, and higher in size and quality than the B-frame. In addition, the B-frame denotes data configuring a screen based upon a key frame located before and after a corresponding frame. The B-frame has the smallest size and the lowest image quality as compared to the other frames (i.e., I-frame and P-frame).

In addition, the image receiver 110 in FIG. 2 receives video data configured as a group (series) of a plurality of bit streams, which have different bit rates and include one or more GOPs. Further, the plurality of bit streams may be bit streams generated by converting the same moving picture. Alternatively, the plurality of bit streams may be bit streams which are converted from the same moving picture to be reproducible with different image qualities.

Also, the streaming server SS can transmit the group of bit streams converted from the same moving picture to the streaming client SC according to a network transmission environment. Further, the bit streams may have different bit rates. Thus, one embodiment of the present invention selects a bit stream having the most optimized bit rate under each network transmission environment. In addition, because the network transmission environment changes as time elapses, the video data can be configured as the collection of bit streams each selected as time elapses.

Further, each GOP included in the bit stream includes an I-frame, and can include a B-frame and/or a P-frame. Based upon the order of the frames to be reproduced, the GOP always begins with the I-frame, and may end with the I-frame or the P-frame. The GOP included in the bit stream also has an I(B^{l}P)^{m}BⁿP structure, where l, m and n denote natural numbers. For instance, the GOP can have the format of IBBBPBBPBBBPBP, IBBBBPBBBPBPBP, IBPBPBP and the like (the I, B and P denote the I-frame, the B-frame and the P-frame, respectively). A string including the I, B and P can also be made by aligning each frame from the left side based upon the order of the frames to be reproduced. In addition, the bit stream may further include a header in which at least one of location information within the bit stream relating to each frame structuring the corresponding bit stream, a video data format and a bit rate.

Next, FIG. 3 is a block diagram of the image transmitting apparatus 200 includes in the streaming server SS according to an embodiment of the present invention. As shown, the image transmitting apparatus 200 includes a database 210 in which video information transmitted through the streaming service is stored. Further, the database 210 can store video data (e.g., moving picture, moving image, etc.) provided through a streaming service, and the stored video data can include a plurality of bit streams, which have different bit rates and each includes one or more GOPs. The plurality of bit streams may be bit streams which are generated by converting the same moving picture, or alternatively may be bit streams which are converted from the same moving picture to be reproducible with different image qualities.

In addition, in FIG. 3, a network detector 230 is configured to detect a transmission environment of a network using information exchanged with the streaming client SC. Also, the controller 220 can select a bit stream from bit streams, which are transmittable under the transmission environment of the network detected by the network detector 230 and transmit the data on a per GOP basis. That is, the controller 220 can select a bit stream with the highest bit rate among the bit streams transmittable under the detected network transmission environment, and transmit the data on a per GOP basis.

Further, the controller 220 can also detect an allowable bandwidth of a network and accordingly calculate a maximum bit rate of a bit stream transmittable according to the bandwidth of the network. Also, the controller 220 can control a data transmitter 240 to select a bit stream, among a plurality of bit streams stored in the database 210, within the currently detected bandwidth of the network. The selected bit stream can thus provide video data with the highest quality without reproduction suspension via the image display apparatus 100. The selected bit stream can then be transmitted on a per GOP basis.

In addition, the controller 220 can control the data transmitter 240 to select a bit stream with the highest bit rate among bit streams transmittable under the detected network transmission environment and transmit the selected bit stream on a per GOP basis. When the selected bit stream is different from a bit stream which is currently being transmitted, the controller 220 can transmit a GOP included in the selected bit stream after completing the transmission of the currently transmitted GOP.

In addition, the image transmitting apparatus 200 can transmit a bit stream with a different bit rate from that of a bit stream which is currently being transmitted due to the change in the network transmission environment. For example, if a bit stream with the higher bit rate than a currently transmitted bit stream is transmittable without unexpected suspension at a receiving end by virtue of increase in a bandwidth allowed in a network, the controller 220 can control the data transmitter 240 to select the bit stream with the higher bit rate than that of the currently transmitted bit stream among bit streams stored in the database 210 and transmit the selected bit stream on a per GOP basis.

Alternatively, if the currently transmitted bit stream is still transmitted when there is a decrease in the bandwidth allowed in the network, a transmission speed of the network cannot provide the bit rate of the currently transmitted bit stream, and a reproduction suspension at the receiving end can occur. Thus, the controller 220 can control the data transmitter 240 to select a bit stream with a bit rate lower than that of the currently transmitted bit stream among the bit streams stored in the database 210 and transmit the selected bit stream on a per GOP basis.

Also, the controller 220 can determine whether the GOP of the currently transmitted bit stream has been completely transmitted. If the GOP of the currently transmitted bit stream has not been completely transmitted, the GOP included in another bit stream can start to be transmitted after the transmission of the currently transmitted GOP of the bit stream is completed.

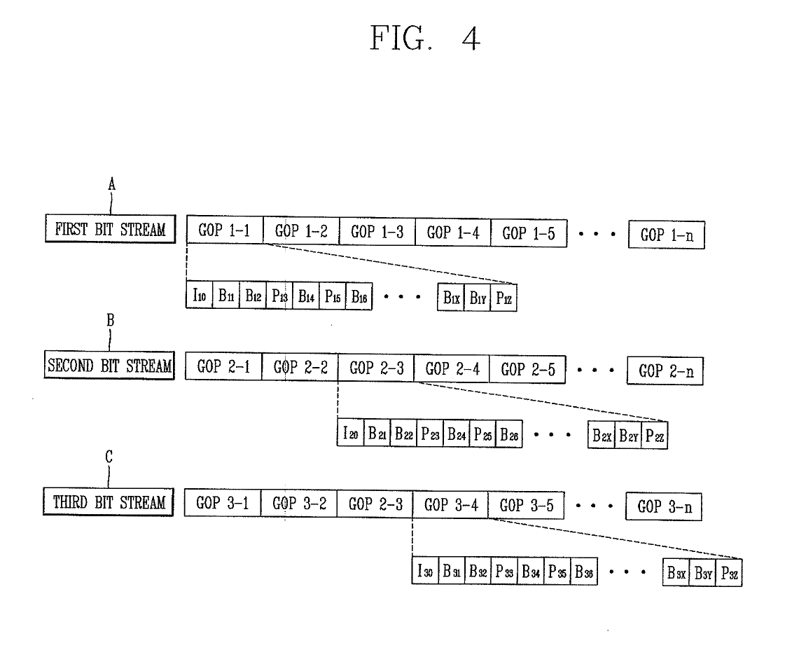

Hereinafter, a recording medium according to an embodiment of the present invention will be described with reference to FIG. 4. Further, a recording medium described in this specification corresponds to a computer-readable recording medium capable of reading and writing data. Examples of such recording media include a flash memory type, a hard disk type, a multimedia card micro type, a memory card type (e.g., SD or XD memory), Random Access Memory (RAM), Static Random Access Memory (SRAM), Read-Only Memory (ROM), Electrically Erasable Programmable Read-only Memory (EEPROM), Programmable Read-only Memory (PROM), magnetic memory, magnetic disk, optical disk, and the like.

In addition, FIG. 4 is an overview illustrating a data format stored in a recording medium according to an embodiment of the present invention. As shown in FIG. 4, the data format on the recording medium can hold (record) video information, which includes a plurality of bit streams having different bit rates and each including one or more GOPs. Further, as discussed above, one of the plurality of bit streams is selected according to a network transmission environment so as to be transmittable via the network on a per GOP basis. The GOP included in the transmitted bit stream begins with an I-frame, and can include a B-frame or a P-frame. In particular, the GOP always begins with the I-frame, and may end with the I-frame or the P-frame and have a B-frame between the beginning and end frames.

Referring to FIG. 4, a plurality of bit streams A, B and C can be recorded in the recording medium. Although only three bit streams are shown in FIG. 4, the number of bit streams may be variously set according to several factors such as a changed level of the network transmission environment and/or the database size of the streaming server SS. The plurality of bit streams A, B and C also include a plurality of GOPs.

Further, as shown in FIG. 4, each GOP included in the bit stream includes an I-frame, a B-frame and a P-frame. For example, regarding GOP1-1 as a first GOP of a first bit stream A, based upon the order of frames to be reproduced, the GOP1-1 begins with the I₁₀ frame as the I-frame and ends with the P_{1Z} frame as the P-frame. One or more B-frames may also be located between the I-frame and the P-frame. In addition, the number and the sequence of the I-frame, B-frame and P-frame structuring each GOP included in the first bit stream A may be differently varied within a range satisfying the criterion that the GOP begins with I-frame and ends with I-frame or P-frame based upon the order of frames to be reproduced. The GOPs included in second and third bit streams may also be structured similar to the GOP1-1.

Further, based on the MPEG video standard, the I-frame is decoded independent of other frames, the P-frame is decoded based upon a previous frame of the corresponding P-frame, and the B-frame is decoded based upon a previous frame and the subsequent frame of the corresponding B-frame. For example, upon decoding frames structuring the GOP1-1 included in the first bit stream A, the I₁₀ frame can be reproduced independent of other frames. On the other hand, in order to reproduce the P₁₃ frame, the P₁₃ frame relies on the preceding frame, namely, the I₁₀, B₁₁ or B₁₂ frame. Also, the B₁₄ frame relies on the preceding I₁₀ or P₁₃ frame and the succeeding P₁₅ frame in order to be reproduced.

As discussed above, the GOP structuring each of plural bit streams begins with the I-frame. Accordingly, a frame located within another GOP prior to the corresponding GOP does not have to be relied on when reproducing a moving picture at a receiving end. Also, the GOP ends with the I-frame or P-frame, and accordingly, a frame located within another GOP following the corresponding GOP does not have to be relied on when reproducing a moving picture at the receiving end. That is, for reproducing frames existing within each GOP, a frame included in another GOP other than the corresponding GOP does not have to be referred to, and thus each GOP can be reproduced independently.

Therefore, even if video data transmitted from the streaming server SS is configured as a group of GOPs extracted from the plurality of bit streams, any problems which may be caused due to consecutive reproduction of GOPs extracted from different bit streams does not occur, because each GOP is independently reproducible. However, if GOPs extracted from different bit streams are consecutively reproduced, and each data frame is reproduced based upon a different frame from a frame which is originally intended to refer to, deterioration of image quality and suspension of video reproduction occurs.

In addition, each bit stream GOP1-1, GOP2-1 and GOP3-1 may include frames required for reproducing the same video section included in the same moving picture. Similarly, GOPs including GOP1-k, GOP2-k and GOP3-k (here, k denotes natural number) may include frames required for reproducing the same video section included in the same moving picture.

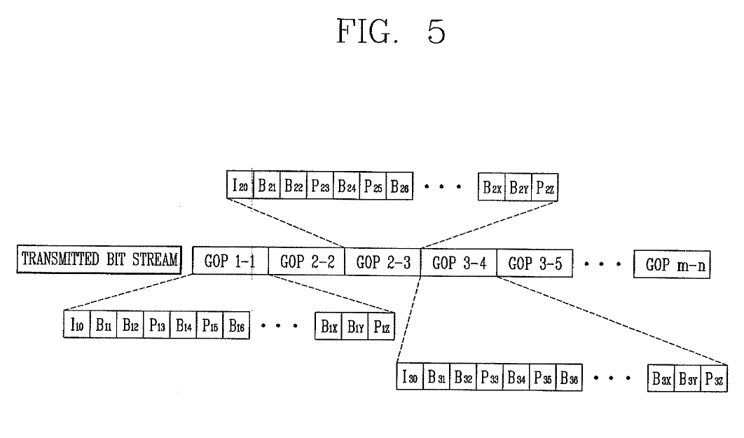

Next, FIG. 5 is an overview showing video information format transmitted by an image reproducing method according to an embodiment of the present invention. The transmitted bit streams in FIG. 5 are structured as a series of GOPs included in different bit streams. For example, in FIG. 5, the initial GOP is GOP1-1 included in the first bit stream A and the subsequent two GOPs are GOP2-2 and GOP2-3 included in the second bit stream B followed by two GOPs, namely, GOP3-4 and GOP3-5 included in the third bit stream C.

Upon reproducing the GOP1-1 at a receiving end, the GOP1-1 ends with the P_{1Z} frame based upon the order of frames to be reproduced. Further, the P_{1Z} frame is reproduced depending on a prior frame prior to the current frame. Accordingly, the P_{1Z} frame can be reproduced based on the I₁₀ frame included in the GOP1-1.

Also, if the GOP1-1 ends with the B_{1X} or B_{1Y} frame other than the P_{1Z} frame, the B_{1X} or B_{1Y} frame can be reproduced based upon other frames included in the GOP2-2 in addition to the I₁₀ frame included in the GOP1-1. That is, the B-frame is reproduced based upon both the preceding frame and the subsequent frame of the corresponding frame.

In more detail, the B_{1X} or B_{1Y} frame is generally a frame generated to be reproduced based on the I₁₀ frame included in the GOP1-1 and a frame included in the GOP1-2. Therefore, if the B_{1X} or B_{1Y} frame relies on a frame included in the GOP2-2 instead of a frame included in the GOP1-2 which is originally intended to refer to, the image quality deteriorates and the video reproduction may be interrupted or halted.

However, according to an embodiment of the present invention, the bit streams in the recording medium are recorded such that each GOP can be independently reproduced without relying on other GOPs. Thus, each GOP is combined from a plurality of bit streams A, B and C, resulting in reproduction of the video data without image quality deterioration and suspension of the reproduction process.

Further, the GOP3-4 in FIG. 5 begins with the I₃₀ frame, which can be reproduced without relying on other frames included in a preceding GOP of the GOP3-4. That is, the I-frame can be reproduced independent of other frames. Thus, because the GOPs included in bit streams stored in the recording medium are independently reproducible, the image quality is not deteriorated and the reproduction is not suspended even when bit streams generated by combining GOPs included in different bit streams are transmitted.

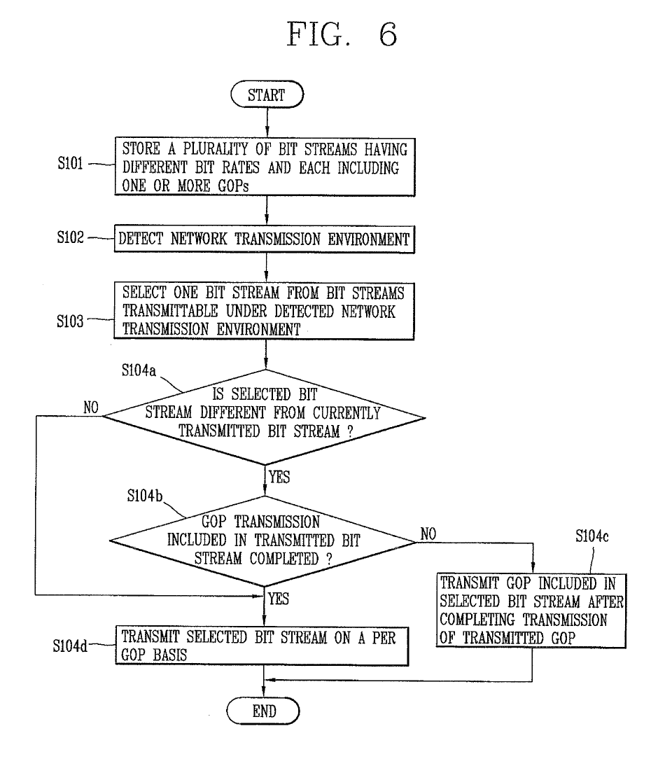

Next, FIG. 6 is a flowchart illustrating a method of transmitting an image according to an embodiment of the present invention. FIG. 3 will also be referred to in this description. As shown in FIG. 6, the controller 220 stores a plurality of bit streams having different bit rates and including one or more GOPs (S101). Then, the network detector 230 detects the network transmission environment (S102).

Upon the network transmission environment being detected (S102), the controller 220 selects a bit stream from a series of bit streams transmittable under the detected network transmission environment (S103). Further, the controller 220 selects the bit stream with the highest bit rate among the bit streams transmittable under the detected network transmission environment. The controller 220 then compares the selected bit stream with a bit stream which is currently being transmitted (S104a).

If the bit streams are different (Yes in S104a), the controller 220 determines whether or not the GOP included in the currently transmitted bit stream has been completely transmitted (S104b). If the GOP included in the currently transmitted bit stream has not been completely transmitted (No in S104b), the controller 220 controls the data transmitter 240 to transmit the selected bit stream on a per GOP basis after completing the ongoing GOP transmission (S104c).

If the GOP transmission of the currently transmitted bit stream has been completed (Yes in S104b), the controller 220 controls the data transmitter 240 to immediately transmit the selected bit stream on a per GOP basis (S104d). Alternatively, if the selected bit stream is the same to the currently transmitted bit stream according to the comparison result (S104a), then the selected bit stream can be immediately transmitted on a per GOP basis.

Thus, the image transmitting method according to embodiments of the present invention can transmit an optimized data stream according to a network transmission environment. Thus, the user can receive a smooth streaming service. Also, the video data can be reproduced without suspension and the image quality is not deteriorated, even when continuous data streams having different bit rates are received.

In addition, the embodiments of the present invention can be implemented in a program-recorded medium as processor-readable codes. Examples of such processor-readable media include ROM, RAM, CD-ROM, magnetic tape, floppy disk, optical data storage element and the like. Also, such processor-readable medium can be implemented via transmission on the Internet. Further, the image display apparatus, the image transmitting apparatus and the recording medium described in the above embodiments may be combined in part or in all in each embodiment.

The foregoing embodiments and advantages are merely exemplary and are not to be construed as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An image display apparatus, comprising:
an image receiver configured to receive video data structured by a plurality of bit streams;
an image processor configured to process the received video data into a reproducible format; and
an image output unit configured to output video relating to the data processed into the reproducible format,
wherein the plurality of bit streams include a first bit stream having a first bit rate and having a format defined by a first group of pictures (GOP), and a second bit stream having a second bit rate and having a format defined by a second group of pictures (GOP)s, and
wherein the received video data includes a mixture of the first GOPs from the first bit stream and the second GOPs from the second bit stream in which each of the GOPs included in the received video data begins with an intra-frame (I-frame) and ends with the I-frame or a predicted-frame (P-frame), and includes a bidirectional-frame (B-frame) between the beginning and end frames such that the first and second GOPs are reproduced independently from each other.

2. The apparatus of claim 1, wherein the plurality of bit streams are bit streams generated by converting a same video.

3. The apparatus of claim 2, wherein the plurality of bit streams are bit streams by converting the same video to be reproducible with different image qualities.

4. The apparatus of claim 1, wherein the GOPs have an I(B^{l}P)^{m}BⁿP structure, where l, m and n denote natural numbers.

5. The apparatus of claim 1, wherein the plurality of bit streams further include a header having location information identifying a location of each frame within a corresponding bit stream, a video data format and a corresponding bit rate.

6. The apparatus of claim 1, wherein the plurality of bit streams further include a third bit stream having a third bit rate and having a format defined by a third group of pictures (GOP).

7. The apparatus of claim 6, wherein the received video data includes a mixture of the first, second and third GOPs in which the first, second and third GOPs are reproduced independently from each other.

8. An image transmitting apparatus, comprising:
a database configured to store a plurality of bit streams having different bit rates;
a network detector configured to detect change in a network transmission environment;
a controller configured to select a bit stream from the plurality of bit streams transmittable under the detected network transmission environment; and
a data transmitter configured to transmit the selected bit stream on a per GOP basis,
wherein the plurality of bit streams include a first bit stream having a first bit rate and having a format defined by a first group of pictures (GOP), and a second bit stream having a second bit rate and having a format defined by a second group of pictures (GOP)s, and
wherein the transmitted bit stream includes a mixture of the first GOPs from the first bit stream and the second GOPs from the second bit stream in which each of the GOPs included in the transmitted bit stream begins with an intra-frame (I-frame) and ends with the I-frame or a predicted-frame (P-frame), and includes a bidirectional-frame (B-frame) between the beginning and end frames such that the first and second GOPs are reproduced independently from each other.

9. The apparatus of claim 8, wherein the plurality of bit streams are bit streams generated by converting the same video.

10. The apparatus of claim 9, wherein the plurality of bit streams are bit streams by converting the same video to be reproducible with different image qualities.

11. The apparatus of claim 8, wherein the GOPs have an I(B^{l}P)^{m}BⁿP structure, where l, m and n denote natural numbers.

12. The apparatus of claim 8, wherein the plurality of bit streams further include a header having location information identifying a location of each frame within a corresponding bit stream, a video data format and a corresponding bit rate.

13. The apparatus of claim 8, wherein the plurality of bit streams further include a third bit stream having a third bit rate and having a format defined by a third group of pictures (GOP).

14. The apparatus of claim 13, wherein the transmitted bit stream includes a mixture of the first, second and third GOPs in which the first, second and third GOPs are reproduced independently from each other.

15. The apparatus of claim 8, wherein the controller is further configured to select a bit stream with the highest bit rate among the bit streams transmittable under the detected network transmission environment.

16. The apparatus of claim 15, wherein the controller is further configured to transmit the GOP included in the selected bit stream after a transmission of a GOP, which is currently being transmitted, is completed, when the selected bit stream is different from the bit stream currently being transmitted.

17. A recording medium including record video information to be reproduced by an image display apparatus, the recording medium comprising:
recorded video data structured by a plurality of bit streams, wherein the plurality of bit streams include a first bit stream having a first bit rate and having a format defined by a first group of pictures (GOP), and a second bit stream having a second bit rate and having a format defined by a second group of pictures (GOP)s, and
wherein the recorded video data includes a mixture of the first GOPs from the first bit stream and the second GOPs from the second bit stream in which each of the GOPs included in the video data begins with an intra-frame (I-frame) and ends with the I-frame or a predicted-frame (P-frame), and includes a bidirectional-frame (B-frame) between the beginning and end frames such that the first and second GOPs are reproduced independently from each other.

18. The recording medium of claim 17, wherein the plurality of bit streams are bit streams generated by converting a same video.

19. The recording medium of claim 18, wherein the plurality of bit streams are bit streams by converting the same video to be reproducible with different image qualities.

20. The recording medium of claim 17, wherein the GOPs have an I(B^{l}P)^{m}BⁿP structure, where l, m and n denote natural numbers.

21. The recording medium of claim 17, wherein the recorded video data further includes a header having location information identifying a location of each frame, a video data format and a corresponding bit rate.

22. The recording medium of claim 17, wherein the plurality of bit streams further include a third bit stream having a third bit rate and having a format defined by a third group of pictures (GOP).

23. The recording medium of claim 22, wherein the recorded video data includes a mixture of the first, second and third GOPs in which the first, second and third GOPs are reproduced independently from each other.

24. An image transmitting method comprising:
storing a plurality of bit streams having different bit rates and each including one or more groups of pictures (GOPs);
detecting a network transmission environment, and selecting one bit stream from bit streams transmittable under the detected network transmission environment; and
transmitting the selected bit stream on a per GOP basis,
wherein the plurality of bit streams include a first bit stream having a first bit rate and having a format defined by a first group of pictures (GOP), and a second bit stream having a second bit rate and having a format defined by a second group of pictures (GOP)s, and
wherein the transmitted bit stream includes a mixture of the first GOPs from the first bit stream and the second GOPs from the second bit stream in which each of the GOPs included in the transmitted bit stream begins with an intra-frame (I-frame) and ends with the I-frame or a predicted-frame (P-frame), and includes a bidirectional-frame (B-frame) between the beginning and end frames such that the first and second GOPs are reproduced independently from each other.

25. The method of claim 24, wherein the plurality of bit streams are bit streams generated by converting the same video.

26. The method of claim 25, wherein the plurality of bit streams are bit streams by converting the same video to be reproducible with different image qualities.

27. The method of claim 24, wherein the GOPs have an I(B^{l}P)^{m}BⁿP structure, where l, m and n denote natural numbers.

28. The method of claim 24, wherein the plurality of bit streams further include a header having location information identifying a location of each frame within a corresponding bit stream, a video data format and a corresponding bit rate.

29. The method of claim 24, wherein the plurality of bit streams further include a third bit stream having a third bit rate and having a format defined by a third group of pictures (GOP).

30. The method of claim 29, wherein the transmitted bit stream includes a mixture of the first, second and third GOPs in which the first, second and third GOPs are reproduced independently from each other.

31. The method of claim 24, wherein the controller is further configured to select a bit stream with the highest bit rate among the bit streams transmittable under the detected network transmission environment.

32. The method of claim 31, wherein the controller is further configured to transmit the GOP included in the selected bit stream after a transmission of a GOP, which is currently being transmitted, is completed, when the selected bit stream is different from the bit stream currently being transmitted.
